(19) United States
(12) Patent Application Publication
(10) Pub. No.: US 2026/0124974 A1
(43) Pub. Date: May 7, 2026

(54) HOMOGENOUS MULTIZONE SEAT HEATER

(71) Applicant: LEAR CORPORATION, Southfield, MI (US)

(72) Inventors: Sumanth Muthyala, Ann Arbor, MI (US); Milan Tüskes, Genova (IT); Adriana Ceballos, Reynosa (MX); Vyachislav Ivanov, West Bloomfield, MI (US); Steven Ziolkowski, Farmington Hills, CT (US)

(21) Appl. No.: 18/939,837

(22) Filed: Nov. 7, 2024

(51) Int. Cl. B60N 2/56; H05B 3/34

(52) U.S. Cl. CPC B60N 2/5685; H05B 3/34

(57) ABSTRACT

A system includes a seat heater that has at least first and second heating circuits that define at least first and second heating zones. The first heating circuit includes first heating coils and the second heating circuit includes second heating coils that are interdigitated with the first heating coils such that the first and second heating zones at least partially overlap each other.

### BACKGROUND

Automobile seats and other types of seats may include a seat bottom, a seat back, and a headrest mounted on the seat back. Many seats also include additional features for the comfort of the seat occupant. For example, seats are known to have inflatable air bladders to adjust occupant support and to provide massaging. Some seats also include temperature controls to provide thermal comfort.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates an example of a seat system.

FIG. 2 illustrates a seat heater for a seat system.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],”depending on the context.

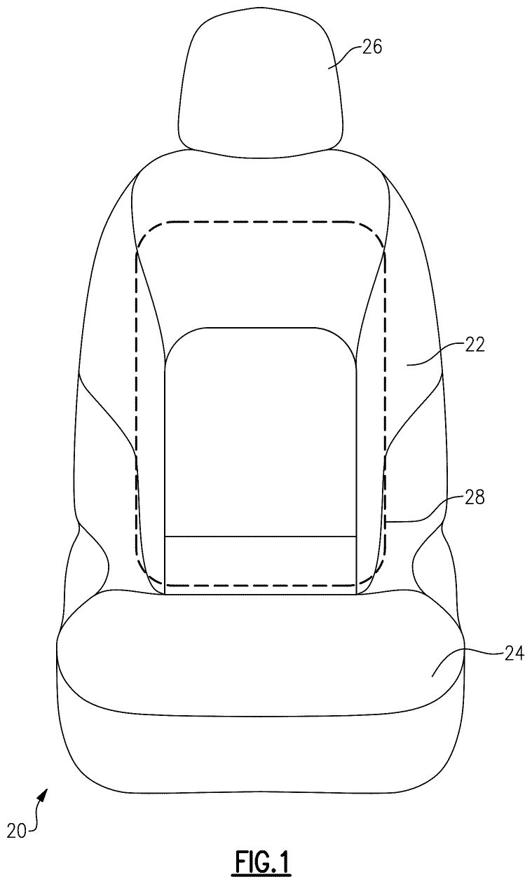

FIG. 1 illustrates an example seat system 20 for an automobile. In this example, the seat system 20 includes a seat back 22, a seat cushion 24, and a headrest 26 mounted on the seat back 22. Although the example seat system 20 is for an automobile, it is to be understood that the examples are applicable to seats for other types of vehicles, such as but not limited to, a motorcycle, a bus, a watercraft, a gaming chair, an aircraft, or a locomotive.

The seat system 20 further includes a seat heater 28 for providing thermal comfort to a seat occupant. The seat heater 28 is positioned to provide heating in the seat back 22, but may additionally or alternatively provide heating in the seat cushion 24. As will be appreciated from the examples herein, the seat heater 28 is configured to provide uniform heating across multiple heating zones.

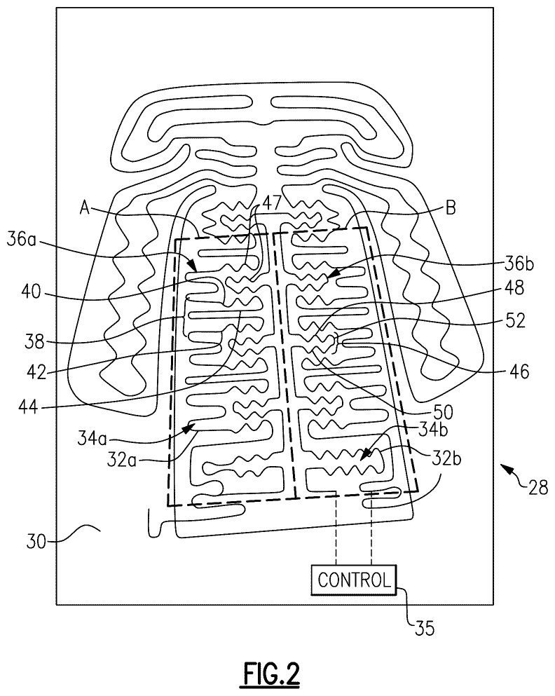

FIG. 2 illustrates the seat heater 28 without the remainder of the seat. The seat heater 28 is carried on a single carrier mat 30, such as a woven or non-woven fabric. The seat heater 28 includes at least first and second heating circuits 32a/32b. A “heating circuit” is an electric current path, such as a resistance heating element wire. As an example, the heating element wires are independently selected from, but are not limited to, pure copper, steel, copper-nickel, copper-magnesium, and copper-tin. In further examples, the heating element wires are independently selected from CuSn0.3, CuSn0.6, and CuSn6. The material of the wires, as well as the wire diameters may be selected to provide a desired heat intensity. In one example, the wires of the heating circuit 32a are of a different diameter than the wires of the heating circuit 32b. In the illustrated example, there are at least two resistance heating element wires that are carried on the mat 30 and that form two distinct electric current paths, i.e., heating zones. For instance, the resistance heating element wires are stitched or sewn onto the mat 30. Each of the heating circuits 32a/32b defines a respective heating zone 34a/34b, which is the area over which the heating circuit 32a or 32b provides heat.

The heating circuits 32a/32b are connected with a controller 35. The controller 35 includes hardware, software, or both. The hardware may include, but is not limited to, one or more microprocessors and one or more memory modules. The controller 35 may be dedicated to controlling the heating circuits 32a/32b or integrated into another controller of the vehicle. As an example, the controller 35 is in communication with one or more sensors (e.g. temperature sensors and electrical resistance sensors) that provide feedback for controlling an ON/OFF state of the heating circuits 32a/32b. For instance, the controller 35 compares feedback values to a lookup table in the memory module and responsively switches the heating circuits 32a/32b (individually or in a coordinated manner together) between ON and OFF.

The first heating circuit 32a includes a first heating coil 36a, and the second heating circuit 32b includes a second heating coil 36b. For example, a heating coil is a series of loops of a resistance heating element wire. A “loop” is a portion of the circuit that turns back on itself at least 180°. Each loop 38 of the first heating coil 36a includes loops sides 40/42 that are joined at one end by a loop turn 44, and each loop 46 of the second heating coil 36b includes loop sides 48/50 joined at one end by a loop turn 52. As will be appreciated, each of these sections of the loop 38 or 46 may include smaller, sub-loops and/or undulations 47 that facilitate expansion of the heating zones 34a/34b. Alternatively, the sections of the loops 38/46 may be formed from straight (non-undulating) resistance heating element wire. A loop that includes one smaller sub-loop is a double-loop, while a loop that does not include any sub-loops is a single-loop. In the illustrated example, the loops 38 are double loops in that the loop turn 44 is a smaller sub-loop.

The opposite end from the loop turn 44 of each loop 38 is an “open” end at which the wire from the sides 40/42 extend away from each other. Similarly, the opposite end from the loop turn 52 of each loop 46 is an “open” end at which the wire from the sides 48/50 extend away from each other. For purpose of describing example configurations, the relative positions of the open ends may be used to define a loop orientation. For instance, relative to a horizontal left-right direction in the figure, an open end that opens toward the right defines a right-handed loop and an open end that opens toward the left defines a left-handed loop.

The loops 46 of the second heating coils 36b are interdigitated with the loops 38 of the first heating coils 36a. This means the loops 46 are interlocked with the loops 38 such that the first and second heating zones 34a/34b at least partially overlap each other. For instance, in the illustrated example, multiple consecutive loops 46 are interlocked with multiple consecutive loops 38 to provide a configuration that has multiple interdigitations. An interdigitation comprises two adjacent loops 38 with a loop 46 interposed between the loops 38. In the illustrated example, the seat heater 28 includes two vertical sets, set A and set B, of interdigitations. In set A, the loops 38 are left-handed and the loops 46 are right-handed, and in set B the loops 38 are right-handed and the loops 46 are left-handed. In further example, the configuration is represented by a ratio of the number of loops 38 that are interdigitated with loops 46. For example, the ratio is from 1:1 to 5:1. Such a ratio range may include configurations in which one ore more loops 38 and one or more loops 46 are not interdigitated. For instance, every other loop 38 or every third loop 38 is interdigitated.

The seat heater 28 provides uniform heating across the heating zones 34a/34b. In the illustrated example, the first heating zone 34a may serve to provide overall seat heating, while the second heating zone may serve to provide additional heating in correspondence to the locations of massaging bladders in the seat. Heating systems that include multiple heating zones on multiple mats in a seat are typically spaced far apart. In such a configuration, when the heating zones are ON there is often a region between the heating zones that is unheated and cooler to the touch than the heating zones. Additionally, when one heating zone is OFF and the other is ON, the zone that is OFF feels cooler to the touch than the zone that is ON. Such cooler areas can be uncomfortable for the seat occupant. In contrast, the interdigitation of the heating circuits 32a/32b provides a spatial configuration in which the heating element wires are of the heating zones 34a/34b close together on the same carrier mat 30. This causes an overlap of the heating zones 34a/34b such that when both zones 34a/34b are ON there is no “cold” region in between the zones. Moreover, when zone 34a is ON and zone 34b is OFF, there zone 34b is not cooler to the touch because the close proximity of the interdigitated zone 34a provides heat.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from this disclosure. The scope of legal protection given to this disclosure can only be determined by studying the following claims.

What is claimed is:

1. A system comprising:
a seat heater comprising at least first and second heating circuits defining at least first and second heating zones, the first heating circuit including first heating coils and the second heating circuit including second heating coils that are interdigitated with the first heating coils such that the first and second heating zones at least partially overlap each other for uniform heating across the first and second heating zones.

2. The system as recited in claim 1, wherein the first heating coil includes first heating coil loops, the second heating coil includes second heating coil loops, and the second heating coil loops are interdigitated with the first heating coil loops.

3. The system as recited in claim 2, wherein the first heating coil loops are left-handed loops and the second heating coil loops are left-handed loops.

4. The system as recited in claim 2, wherein the first heating coil loops are double-loops, and the second heating coil loops and single-loops.

5. The system as recited in claim 1, wherein the first and second heating coils are independently selected from the group consisting of pure copper, steel, copper-nickel, copper-magnesium, and copper-tin.

6. The system as recited in claim 1, wherein the heating coils are independently selected from the group consisting of CuSn0.3, CuSn0.6, and CuSn6.

7. The system as recited in claim 1, wherein the heating coils have different diameter wires from each other.

8. The system as recited in claim 1, wherein the heating circuits are independent such that each can be independently be turned ON/OFF.

9. The system as recited in claim 1, further comprising a single carrier mat carrying the first and second heating circuits.

10. The system as recited in claim 1, wherein a ratio of the heating coils of the first circuit that are interdigitated with the heating coils of the second circuit is from 1:1 to 5:1.

11. The system as recited in claim 1, further comprising a seat including the seat heater.

12. A system comprising:
a seat;
a single carrier mat in the seat;
a seat heater comprising at least first and second heating circuits carried on the carrier mat, the first and second heating circuits defining at least first and second heating zones that at least partially overlap each other for uniform heating across the first and second heating zones.

13. The system as recited in claim 12, wherein the first heating circuit includes first heating coils and the second heating circuit includes second heating coils that are interdigitated with the first heating coils.

14. The system as recited in claim 13, wherein the first heating coil includes first heating coil loops, the second heating coil includes second heating coil loops, and the second heating coil loops are interdigitated with the first heating coil loops.

15. The system as recited in claim 14, wherein the first heating coil loops are double-loops, and the second heating coil loops and single-loops.

16. The system as recited in claim 14, wherein the heating circuits are independent such that each can be independently be turned ON/OFF.

17. The system as recited in claim 16, wherein the heating coils have different diameter wires from each other.
